(19) United States
(12) Patent Application Publication
(10) Pub. No.: US 2005/0211000 A1
(43) Pub. Date: Sep. 29, 2005

(54) Flowmeter

(76) Inventor: Isao Suzuki, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/074,838

(22) Filed: Mar. 9, 2005

(30) Foreign Application Priority Data
Mar. 24, 2004 (JP) 86270/2004

(51) Int. Cl. G01F 1/32

(52) U.S. Cl. 73/861.52

(57) ABSTRACT

In a flowmeter of the present invention, there are provided a single differential pressure gauge using metal diaphragms, and an orifice member replaceable according to a range of a flow rate to be measured. The differential pressure gauge comprises a disk-like ceramic electrode having upper and lower electrode surfaces, and a pair of metal diaphragms disposed so as to face the ceramic electrode while being equally spaced from the electrode surfaces of the ceramic electrode. The differential pressure gauge is disposed in a fluid flow passage including the orifice member, in a manner such that fluid pressures on an upstream side and a downstream side of the orifice member act on respective fluid-exposed surfaces of the metal diaphragms. A differential pressure is detected from a change in capacitance between each diaphragm and the corresponding electrode surface of the ceramic electrode, to thereby determine a flow rate.

### BACKGROUND OF THE INVENTION

The present invention relates to a flowmeter. Specifically, the present invention relates to a flowmeter which can be advantageously used for measuring a flow rate of a high-purity liquid, such as a chemical liquid.

For measuring a flow rate of a chemical liquid, a flowmeter made of Teflon is used so as to prevent the liquid measured from being contaminated with metal ions. In a flowmeter of this type, generally, measurement is conducted with respect to a differential time of propagation of ultrasonic waves consequent on a flow velocity of the fluid. However, in using such a system, when a flow rate is low, significant measurement errors are likely to occur. Especially when a flow rate is 100 ml per minute or less, accurate flow rate measurement is difficult to achieve. Further, if air bubbles are present in the fluid, ultrasonic waves are not stably propagated, which makes accurate measurement difficult.

U.S. Pat. No. 6,578,435 discloses a system using a nozzle and two diaphragm-type pressure gauges each comprising a diaphragm coated with Teflon. In this system, each pressure gauge detects a pressure generated when a fluid passes through the nozzle, and a flow rate is determined from a difference between the pressures detected by the two pressure gauges. In this system, a minimum flow rate as low as several ten cc per min. can be measured. However, a problem arises, such that costs increase due to a need to provide two pressure gauges having the same characteristics. Further, to attain a desired strength, a thickness of the Teflon-coated diaphragm must be increased to some extent. As a result of increasing this thickness, however, hysterisis occurs, thereby limiting resolution and sensitivity of the flowmeter.

### SUMMARY OF THE INVENTION

In view of the above problems of the prior art, the present invention has been made. It is an object of the present invention to provide a flowmeter which enables direct detection of a flow rate of a fluid and which can be manufactured at low cost.

The present invention provides a flowmeter comprising:

a fluid flow passage including a flow inlet and a flow outlet;

an orifice member disposed in the fluid flow passage; and

a differential pressure gauge including two diaphragms, one of said two diaphragms being adapted to make contact with a fluid to be measured on an upstream side of the orifice member, and the other diaphragm being adapted to make contact with the fluid to be measured on a downstream side of the orifice member.

In the differential pressure gauge using diaphragms, a pair of diaphragms made of a metal are disposed so as to face a disk-like ceramic electrode. In upper and lower surfaces of the ceramic electrode there are formed metal electrode surfaces. The diaphragms are disposed to be each equally spaced apart from the metal electrode surfaces of the ceramic electrode. The metal electrode surfaces of the ceramic electrode are adapted to be electrically connected to the outside of the ceramic electrode, without making direct contact with the metal diaphragms. Thus, one metal electrode surface of the ceramic electrode faces one metal diaphragm, with a gap being formed therebetween to form a capacitor. Another capacitor is formed between the other electrode surface of the ceramic electrode and the other metal diaphragm. A surface of the metal diaphragm which is in opposing relation to the surface facing the ceramic electrode is exposed to a fluid to be controlled; and it is coated with a fluoropolymer, such as Teflon, so as to prevent contamination of a fluid to be measured. Preferably, all parts that are exposed to a fluid to be measured, other than the above-mentioned electrode, are formed from a fluoropolymer. A capacitance of the capacitor changes depending on a gap that exists between the electrode surface and the metal diaphragm, and this gap varies depending on a displacement or deflection of the metal diaphragm. For example, when the gap becomes small, the capacitance becomes large, and when the gap becomes large the capacitance becomes small.

In the flowmeter of the present invention, a fluid flow passage is formed so as to connect the fluid-exposed surface of one metal diaphragm of the differential pressure gauge and the fluid-exposed surface of the other metal diaphragm of the differential pressure gauge. The orifice member is disposed at an intermediate part of the fluid flow passage. Therefore, a fluid pressure on an upstream side of the orifice member acts on the surface of one metal diaphragm of the differential pressure gauge, and the fluid pressure on a downstream side of the orifice member acts on the surface of the other metal diaphragm of the differential pressure gauge. The pressures on the upstream side and the downstream side of the orifice member act to change the respective values of the capacitors formed by the two metal diaphragms. Therefore, by detecting the respective values of the capacitors, a corresponding fluid flow rate can be determined.

When the two diaphragms are connected by means of a rigid rod, the diaphragms are displaced according to a difference between fluid pressures acting on the respective fluid-exposed surfaces of the diaphragms. By electrically detecting as a difference in capacitance between the capacitors a position of the diaphragms after displacement, a difference between the fluid pressures acting on opposing surfaces of the diaphragms can be determined. From the thus determined difference between the fluid pressures, a flow rate of the fluid flowing in the fluid flow passage can be determined.

The orifice member is preferably formed as an orifice plug which is removably plugged into the fluid flow passage. Measurement of a flow rate can be conducted within a wide range by selectively using orifice plugs having various conductances that are determined by orifice diameters and orifice shapes.

In the above explanation, the diaphragms are connected by means of a rigid rod so that a differential pressure can be directly detected from displacement of the diaphragms. However, a differential pressure may be determined by creating a vacuum in a space between the diaphragms or by introducing a negative pressure into the space between the diaphragms so that the capacitors detect absolute fluid pressures. In this case, a differential pressure is determined by calculating a difference between the detected absolute pressures. The negative pressure is preferably 1 Pa or less.

In the present invention, a flowmeter is formed as a single differential pressure gauge comprising a single orifice member and two opposing diaphragms. Therefore, the flowmeter of the present invention has a simple structure and can be manufactured at low cost.

Further, since the differential pressure gauge is housed within the fluid flow passage, leakage of a fluid to be measured to the outside of the passage will not occur even if one or other of the diaphragms breaks. Therefore, measurement of a flow rate of a harmful fluid can be conducted with high safety.

Further, as stated, at least a part of each of the two diaphragms is made of a metal, with a fixed electrode being disposed in proximity to each of the two diaphragms to form a capacitor between the fixed electrode and each of the two diaphragms. By detecting a differential pressure based on a difference in capacitance between the capacitors, thermal noise generated due to use of a resistance strain gauge is avoided, and detection of signals can be conducted with high sensitivity.

Further, by providing a rigid rod between the two opposing diaphragms so that a pressure acting on one diaphragm can be transmitted to the other diaphragm, only a change in the difference between the pressures received by the two diaphragms is detected. Further, use of a rigid rod between the diaphragms increases their strength and enables the flowmeter to be used under high fluid pressures.

By maintaining a space between the two opposing diaphragms under vacuum, absolute pressures acting on the diaphragms and a difference therebetween can be detected, whereby a flow rate of even a compressible fluid can be accurately measured.

The metal parts of the two diaphragms may be electrically connected to each other, and thus imparted with the same electric potential. In this case, since an electric shield is created, signals to be detected are kept stable without being affected by external noise.

By forming the orifice member as a plug that is detachable for replacement, measurement of a flow rate can be conducted within a wide range. Further, by making the orifice member detachable, repair or maintenance that may be required due to contamination of the orifice member can be easily conducted.

Further, by forming all parts in contact with a fluid to be measured from a fluoropolymer, contamination of the fluid with metal ions can be avoided, and a flow rate of a highly pure fluid can be measured.

### BRIEF DESCRIPTION OF THE DRAWINGS

FIG. 1 comprises a top view and a side sectional view of a flowmeter according to one embodiment of the present invention.

FIG. 2 is a cross-sectional view, taken along the line A-A′ in FIG. 1.

FIG. 3 is a disassembled view of a differential pressure gauge used in the embodiment of FIG. 1.

FIG. 4 is a side view and a bottom view of an orifice plug used in the embodiment of FIG. 1.

FIG. 5 is a disassembled view of a differential pressure gauge used in a flowmeter according to another embodiment of the present invention.

### DETAILED DESCRIPTION OF THE INVENTION

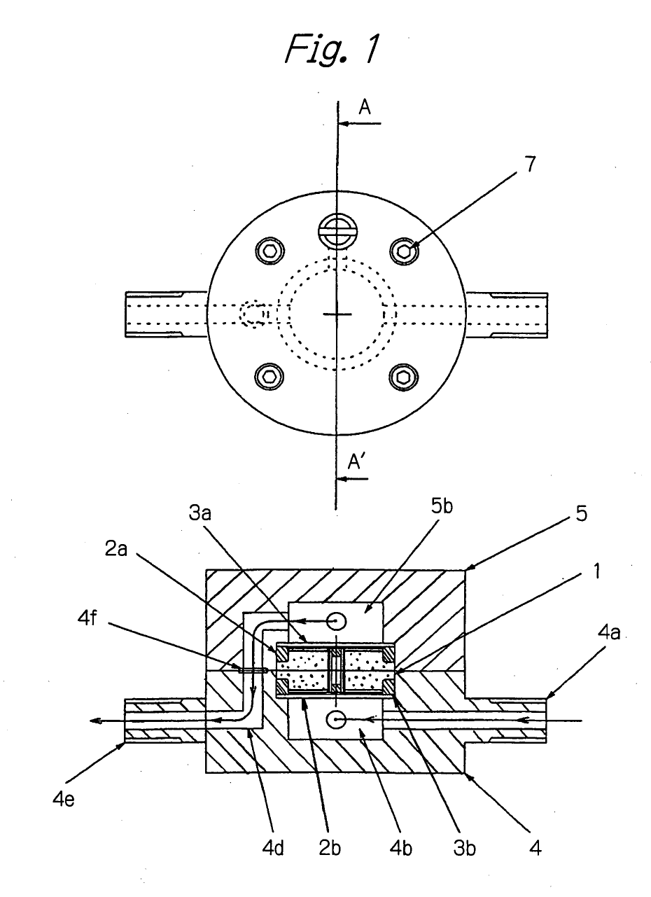

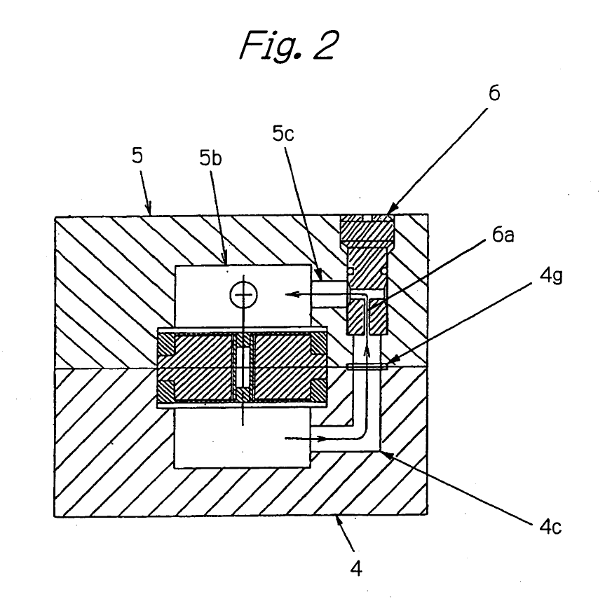

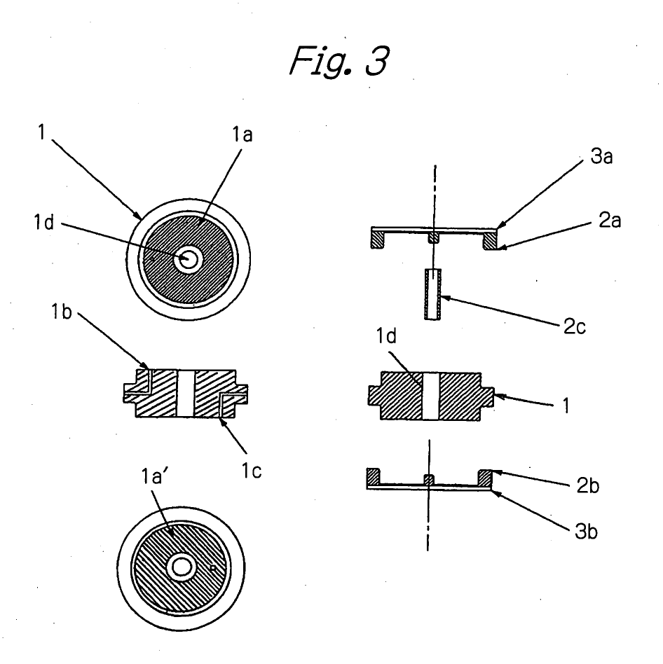

FIG. 1 comprises a top view and a side sectional view of a flowmeter according to one embodiment of the present invention. FIG. 2 is a cross-sectional view, taken along the line A-A′ in FIG. 1. In FIG. 1, a base 4 made of Teflon includes a flow inlet 4a and a flow outlet 4e for a fluid to be measured. A cover 5 made of Teflon is sealably connected to an upper portion of the base 4 by means of bolts 7. A chamber or a space is formed between the base 4 and the cover 5, and a differential pressure gauge having arrangements shown in FIG. 3 is housed within the space. As shown in FIG. 2, a fluid flow passage is formed, so as to bypass the chamber or space. An orifice plug 6 is detachably plugged into an intermediate part of the fluid flow passage. The fluid flows into the fluid flow passage through the flow inlet 4a, enters a chamber 4b, passes through a passage 4c shown in FIG. 2, an orifice 6a of the orifice plug 6 and a passage 5c, and enters a chamber 5b. Thereafter, the fluid passes through a passage 4d and exits the fluid flow passage through the flow outlet 4e. Reference numerals 4g and 4f denote O-rings made of Teflon for preventing leakage of the fluid.

FIG. 3 is a disassembled view of the differential pressure gauge used in the embodiment of FIG. 1. Metal diaphragms 2a and 2b are gas-tightly connected to an upper surface and a lower surface of a disk-like ceramic electrode 1, by means of brazing. Electrode surfaces 1a and 1a′ are formed in the upper surface and the lower surface of the ceramic electrode 1, by means of electrically conductive metal plating. Through-holes 1b and 1c are also plated with an electrically conductive metal. Thus, each of the upper and lower electrode surfaces of the ceramic electrode is electrically insulated, and the through-holes for electrical connection extend from the electrode surfaces to a side surface of the ceramic electrode. By means of lead wires or the like (not shown), such conductive electrodes are electrically connected through the side surface of the ceramic electrode to the outside of the base 4.

The diaphragm 2a, together with the electrode surface 1a, forms one capacitor, and the diaphragm 2b, together with the electrode surface 1a′, forms another capacitor.

Surfaces of the metal diaphragms 2a and 2b on a side opposite to the ceramic electrode are provided with Teflon coatings 3a and 3b, respectively. Surfaces of the metal diaphragms 2a and 2b on a side opposite to the Teflon coating surfaces 3a and 3b each include a projection. The projection is formed at a central portion of the surface of each of the metal diaphragms 2a and 2b, and is press-fitted into a rigid metal rod 2c. The metal rod 2c is inserted, without large play, through a through-hole 1d formed along the center axis of the ceramic electrode 1 so as to allow the metal rod to move in the through-hole without resistance. Thus, the metal diaphragms 2a and 2b are connected to each other by means of the rod 2c, with the ceramic electrode 1 being provided therebetween. Thus, the differential pressure gauge is formed as an integral part of the flowmeter, and housed within the space between the base 4 and the cover 5 in a gas-tight manner.

Although not clearly shown in the figures, a slight gap is formed between each of the metal diaphragms 2a and 2b and the corresponding electrode surface of the ceramic electrode 1. This gap is determined such that in the case of an electrode for diaphragms having an outer diameter of 25 mm, a capacitance of about 30 pF is generated between each of the metal diaphragms and the corresponding electrode surface of the electrode. The Teflon coating surfaces 3a and 3b of the metal diaphragms 2a and 2b receive a pressure due to the fluid in the fluid flow passage. When the Teflon coating surfaces 3a and 3b receive a pressure of the fluid flowing in the fluid flow passage, the metal diaphragms 2a and 2b are deformed by deflection. The capacitances of the two capacitors vary, depending on amounts of deflection of the corresponding metal diaphragms. When the gap decreases, the capacitance increases. When the gap increases, the capacitance decreases. In the arrangements shown in FIGS. 1 and 2, when the fluid flows, the Teflon coating surface 3b of the diaphragm 2b is subject to a pressure required to pass the fluid through the orifice member 6, which pressure exceeds that to which the surface 3a is subject. Since the two diaphragms on the upper side and the lower side of the ceramic electrode are connected by means of the rigid rod 2c, each of the diaphragms moves in an upward direction (as viewed in the sectional view of FIG. 1) according to the flow rate of the fluid flowing into the chamber 4b. Consequently, a capacitance generated between the diaphragm 2b and the corresponding electrode surface increases, and a capacitance generated between the diaphragm 2a and the corresponding electrode surface decreases. That is, a difference is produced between the capacitances of the two capacitors, as a result of a difference between the pressures acting on the respective diaphragms. By electrically detecting the difference in capacitance and using such a difference to indicate the differential pressure between the diaphragms, a flow rate can be determined.

For measuring a flow rate of a fluid having a density that varies with a fluid pressure, measurement can be conducted highly accurately by providing another pressure gauge (not shown) for detecting a fluid pressure and correcting an output of the flowmeter based on a signal output from this pressure gauge. When a fluid pressure increases, each of the diaphragms, which is held at a central portion thereof, is caused to be slightly deformed inward at an intermediate portion thereof, and therefore, a capacitance of each of the two capacitors slightly increases. When the capacitances of the two capacitors vary due to a variance in differential pressure, a capacitance of one capacitor increases while that of the other capacitor decreases. Consequently, it is possible to determine a fluid pressure from an algebraic sum of the respective capacitances of the capacitors. It is also possible to correct an output of the flowmeter based on a signal of the thus determined fluid pressure.

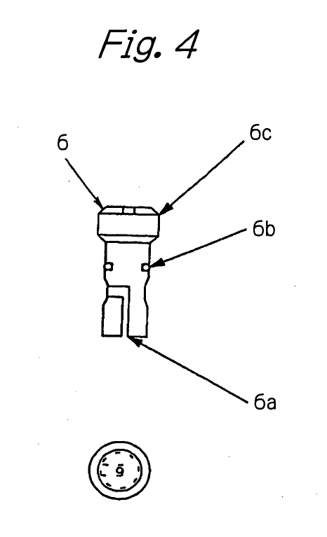

FIG. 4 consists of a side view and a bottom view of the orifice plug 6 used in the embodiment of FIGS. 1 and 2. The orifice plug 6 is made of Teflon, and a fluid inlet portion and a fluid outlet portion of the orifice 6a have different flow path diameters. The orifice plug 6 is threadably engaged with the cover 5 by means of a screw portion 6c, as shown in FIG. 2. An O-ring 6b made of Teflon is provided, so as to prevent leakage of the fluid. As indicated in FIG. 2, by providing the orifice plug 6 and the differential pressure gauge of FIG. 3 in the fluid flow passage, a differential pressure generated when the fluid passes through the orifice 6a can be detected, to thereby determine the flow rate of the fluid.

The orifice plug 6 is detachably attached to the cover 5. As the orifice plug 6, a plurality of orifice plugs having different orifice shapes may be prepared for selective use. By selectively using an orifice plug according to a flow rate to be measured, measurement of a flow rate can be conducted over a wide range.

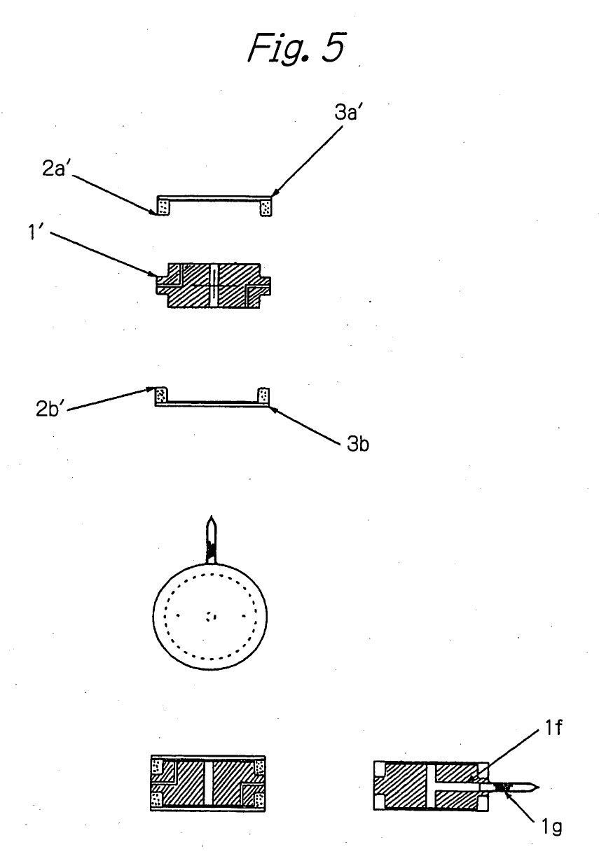

FIG. 5 is a disassembled view of a differential pressure gauge usable in a flowmeter according to another embodiment of the present invention. In this embodiment, there is no rod for connecting diaphragms 2a′ and 2b′. After sealably connecting a ceramic electrode 1′ and the metal diaphragms 2a′ and 2b′ by means of brazing, a vacuum is created in a space surrounded by the diaphragms and the ceramic electrode. A metal pipe 1g is fittingly inserted into the ceramic electrode 1′ from a forward end of an opening 1f. After the vacuum is created, the pipe 1g is sealed. A getter material is embedded in part of the metal pipe 1g so as to maintain the vacuum. As in the previous embodiment, two capacitances are created by means of the ceramic electrode 1′ and the diaphragms 2a′ and 2b′.

In this embodiment, the diaphragms 2a′ and 2b′ are not connected by a rod. Therefore, each of the diaphragms independently deforms relative to the vacuum according to a pressure applied, and the two capacitances vary independently of each other. A pressure in this embodiment is an absolute pressure, and therefore a change in capacitance indicates a change in absolute pressure. By detecting a difference between the two capacitances, a difference between absolute pressures can be determined, to thereby measure a flow rate. In this embodiment, each capacitance value corresponds to an absolute pressure based on a vacuum. Therefore, it is possible to detect not only the flow rate of a liquid, but also the flow rate of a compressible fluid having a volume varied with pressure.

Embodiments of the present invention have been described above in detail. Without departing the spirit and the scope of the present invention, various changes and modifications are possible. For example, instead of coating the metal diaphragm with Teflon, the metal diaphragm may be covered with a thin, disk-like Teflon sheet. Instead of connecting the two diaphragms of the differential pressure gauge by means of a rod, silicone oil may be sealably contained in a space between the diaphragms.

Needless to say, a common semiconductor resistance strain gauge may be applied to each diaphragm so as to detect a pressure acting on the diaphragm.

The flowmeter of the present invention can be advantageously used for controlling a flow rate of a chemical liquid. However, this does not limit the present invention. The present invention may be applied to controlling flow rates of various fluids.

1. A flowmeter comprising:
a fluid flow passage including a flow inlet and a flow outlet;
an orifice member disposed in the fluid flow passage; and
a differential pressure gauge including two diaphragms, one of said two diaphragms being adapted to make contact with a fluid to be measured on an upstream side of the orifice member, and the other diaphragm being adapted to make contact with the fluid to be measured on a downstream side of the orifice member.

2. A flowmeter according to claim 1, wherein said two diaphragms are provided with means that allows a pressure acting on one of said diaphragms to be transmitted to the other diaphragm.

3. A flowmeter according to claim 2, wherein a part that makes contact with the fluid to be measured is at least partially formed from a fluoropolymer.

4. A flowmeter according to claim 3, wherein an output of the flowmeter is corrected, based on a signal of a fluid pressure.

5. A flowmeter according to claim 1, wherein:
said orifice member is detachable for replacement; and
a configuration of an orifice passage can be changed, according to a flow rate to be measured.

6. A flowmeter comprising:
a fluid flow passage including a flow inlet and a flow outlet;
an orifice member disposed in the fluid flow passage; and
a differential pressure gauge including two diaphragms, one of said two diaphragms being adapted to make contact with a fluid to be measured on an upstream side of the orifice member, and the other diaphragm being adapted to make contact with the fluid to be measured on a downstream side of the orifice member,
wherein at least a part of each of said diaphragms is made of a metal, and two capacitors are formed by said diaphragms and a disk-like electrodes located near by said diaphragms, and wherein said two diaphragms are provided with means that allows a pressure acting on one of said diaphragms to be transmitted to the other diaphragm.

7. A flowmeter according to claim 6, wherein an output of the flowmeter is corrected, based on a signal of a fluid pressure.

8. A flowmeter according to claim 7, wherein said signal of the fluid pressure is detected, based on an algebraic sum of the capacitances of said two capacitors.

9. A flowmeter according to claim 6, wherein a part that makes contact with the fluid to be measured is at least partially formed from a fluoropolymer.

10. A flowmeter comprising:
a fluid flow passage including a flow inlet and a flow outlet;
an orifice member disposed in the fluid flow passage; and
a differential pressure gauge including two diaphragms, one of said two diaphragms being adapted to make contact with a fluid to be measured on an upstream side of the orifice member, and the other diaphragm being adapted to make contact with the fluid to be measured on a downstream side of the orifice member,
wherein at least a part of each of said diaphragms is made of a metal, and two capacitors are formed by said diaphragms and a disk-like electrodes located near by said diaphragms, and wherein a space between said two diaphragms is held under vacuum at a pressure of 1 Pa or less.

11. A flowmeter according to claim 2, wherein:
said orifice member is detachable for replacement; and
a configuration of an orifice passage can be changed, according to a flow rate to be measured.

12. A flowmeter according to claim 3, wherein:
said orifice member is detachable for replacement; and
a configuration of an orifice passage can be changed, according to a flow rate to be measured.

13. A flowmeter according to claim 4, wherein:
said orifice member is detachable for replacement; and
a configuration of an orifice passage can be changed, according to a flow rate to be measured.
